(19) United States
(12) Patent Application Publication
(10) Pub. No.: US 2014/0281368 A1
(43) Pub. Date: Sep. 18, 2014

(54) CYCLE SLICED VECTORS AND SLOT EXECUTION ON A SHARED DATAPATH

(71) Applicant: QUALCOMM INCORPORATED, San Diego, CA (US)

(72) Inventors: Ajay Anant Ingle, Austin, TX (US); Lucian Codrescu, Austin, TX (US); David J. Hoyle, Austin, TX (US); Jose Fridman, Waban, MA (US); Marc M. Hoffman, Mansfield, MA (US); Deepak Mathew, Acton, MA (US)

(73) Assignee: QUALCOMM INCORPORATED, San Diego, CA (US)

(21) Appl. No.: 13/829,503

(22) Filed: Mar. 14, 2013

(51) Int. Cl. G06F 9/30

(52) U.S. Cl. CPC G06F 9/30036
USPC 712/4; 712/206

(57) ABSTRACT

An example method for executing multiple instructions in one or more slots includes receiving a packet including multiple instructions and executing the multiple instructions in one or more slots in a time shared manner. Each slot is associated with an execution data path or a memory data path. An example method for executing at least one instruction in a plurality of phases includes receiving a packet including an instruction, splitting the instruction into a plurality of phases, and executing the instruction in the plurality of phases.

### FIELD OF DISCLOSURE

The present disclosure generally relates to processors, and more particularly to executing instructions in a processor.

### BACKGROUND

A Very Long Instruction Word (VLIW) architecture may use static scheduling and may conventionally depend on a compiler to schedule concurrent instructions and rearrange them into a long instruction word. Such a compiler may perform scheduling for parallel execution of the VLIW instructions.

In the VLIW architecture, the compiler may decide what can be executed in parallel, and the hardware may execute the instructions. For example, a processor having four execution units may receive four instructions and execute these four instructions in parallel in each of the four execution units. There are some instances, however, where a processor does not have a sufficient quantity of execution units to execute the four instructions in parallel. A solution to this problem may be to add more hardware. It may be undesirable, however, to add more hardware because this may increase the size of the machine.

Further, it may be desirable to reduce the size of the execution unit. The amount of data to process for an instruction, however, may be huge. Reducing the size of an execution unit may lead to problems in processing the data associated with the instruction.

### BRIEF SUMMARY

This disclosure relates to processors. Methods, systems, and techniques for executing instructions in a processor are provided.

According to an embodiment, a method for executing multiple instructions in one or more slots includes receiving a packet including multiple instructions. The method also includes executing the multiple instructions in one or more slots in a time shared manner. Each slot is associated with an execution data path or a memory data path.

According to another embodiment, a processor includes a fetch unit to receive a packet including multiple instructions. The processor also includes one or more execution units to execute the multiple instructions in one or more slots in a time shared manner. Each slot is associated with an execution data path or a memory data path.

According to another embodiment, a computer-readable medium has stored thereon computer-executable instructions for performing operations including receiving a packet including multiple instructions and executing the multiple instructions in one or more slots in a time shared manner. Each slot is associated with an execution data path or a memory data path.

According to another embodiment, an apparatus for executing multiple instructions in one or more slots includes means for receiving a packet including multiple instructions and means for executing the multiple instructions in one or more slots in a time shared manner. Each slot is associated with an execution data path or a memory data path.

According to another embodiment, a method for executing at least one instruction in a plurality of phases includes receiving a packet including at least one instruction. The method also includes splitting an instruction of the at least one instruction into a plurality of phases. The method further includes executing the instruction in the plurality of phases.

According to another embodiment, a processor includes a fetch unit to receive a packet including at least one instruction. The processor also includes one or more execution units to split an instruction of the at least one instruction into a plurality of phases and execute the instruction in the plurality of phases.

According to another embodiment, a computer-readable medium has stored thereon computer-executable instructions for performing operations including receiving a packet including at least one instruction, splitting an instruction of the at least one instruction into a plurality of phases, and executing the instruction in the plurality of phases.

According to another embodiment, an apparatus for executing multiple instructions in one or more slots includes means for receiving a packet including at least one instruction, means for splitting an instruction of the at least one instruction into a plurality of phases, and means for executing the instruction in the plurality of phases.

### BRIEF DESCRIPTION OF THE DRAWINGS

The accompanying drawings, which form a part of the specification, illustrate embodiments of the invention and together with the description, further serve to explain the principles of the embodiments. In the drawings, like reference numbers may indicate identical or functionally similar elements. The drawing in which an element first appears is generally indicated by the left-most digit in the corresponding reference number.

FIG. 1 is a block diagram illustrating a system for executing multiple instructions in one or more slots, according to an embodiment.

FIG. 2 is a block diagram illustrating the execution of multiple instructions in one or more slots, according to an embodiment.

FIG. 3 is a block diagram illustrating the execution of an instruction in a slot in a plurality of phases, according to an embodiment.

FIG. 4 is a block diagram illustrating the execution of an instruction in a plurality of phases, according to an embodiment.

FIG. 5 is a simplified flowchart illustrating a method for executing multiple instructions in one or more slots, according to an embodiment.

FIG. 6 is a simplified flowchart illustrating a method for executing at least one instruction in a plurality of phases, according to an embodiment.

FIG. 7 is a block diagram illustrating a wireless device including a digital signal processor, according to an embodiment.

### DETAILED DESCRIPTION

I. Overview

II. Example Processor Architecture
A. Slot Based Slicing
B. Phase Based Slicing
C. Write Patterns
D. Forwarding Network

III. Example Methods

IV. Example Wireless Device

### I. Overview

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

### II. Example Processor Architecture

### A. Slot Based Slicing

FIG. 1 is a block diagram illustrating a system 100 for executing multiple instructions in one or more slots, according to an embodiment.

System 100 includes a processor 101 that processes one or more very long instruction word (VLIW) packets. Processor 101 includes a virtual FIFO (VFIFO) 104 that stores M packets, where M is a whole number that is greater than zero. In FIG. 1, VFIFO 104 stores a set of VLIW packets 102 including VLIW packets 102A, 102B, 102C, and 102D.

Each VLIW packet may include one or more instructions. For example, VLIW packet 102A includes multiple instructions. VLIW packet 102A includes instruction 112 in slot 0, instruction 114 in slot 1, instruction 116 in slot 2, and instruction 118 in slot 3. Each instruction of the multiple sets of instructions may include a fixed number of bits. In an example, each of the multiple instructions includes 32 bits.

Processor 101 may be a pipelined processor that retrieves VLIW packets in a fetch stage of the processor pipeline. In an example, processor 101 may retrieve a VLIW packet from a tightly coupled memory (TCM) (not shown) associated with processor 101. In another example, processor 101 may retrieve VLIW packet from an instruction cache (not shown) associated with processor 101. In another example, processor 101 may be a co-processor that retrieves VLIW packet 102 from another processor via VFIFO 104.

Processor 101 includes an M:1 VFIFO Entry Select Mux 120 that receives up to M packets stored in VFIFO 104 as input and selects a packet from the one to M packets. Multiplexor 120 may be a combinational circuit that selects a packet from the one to M packets for entry into N:1 Slot Mux 122, where N is a whole number that is greater than zero. N may be a quantity of instructions included in a VLIW packet. In FIG. 1, N is four. M:1 VFIFO Entry Select Mux 120 may copy bits from the selected packet into an output bus and send the selected packet to N:1 Slot Mux 122. The selected packet may include multiple instructions, and N:1 Slot Mux 122 may select an instruction from the multiple instructions for execution.

In an example, VLIW packets 102A, 102B. 102C, and 102 D are inputs into M:1 VFIFO Entry Select Mux 120, and VLIW packet 102 A is selected for entry into N:1 Slot Mux 122. N:1 Slot Mux 122 may receive VLIW packet 102A including four instructions 112, 114, 116, and 118. N:1 Slot Mux 122 may select an instruction from instructions 112, 114, 116, and 118 for execution. N:1 Slot Mux 122 may be a combinational circuit that selects an instruction from multiple instructions. N:1 Slot Mux 122 may copy bits from a selected instruction into an output bus and send the selected instruction 124 to an execution unit.

Processor 101 may execute the multiple instructions in one or more slots in a time shared manner, each slot being associated with an execution data path or a memory data path. VLIW packet 102A may be decoded at a decode stage of the processor pipeline, after which the multiple sets of instructions included in VLIW packet 102A may be sent to an execution stage of the processor pipeline. Each of the instructions included in VLIW packet 102A may enter an execution unit.

In an embodiment, the quantity of instructions included in VLIW packet 102A is less than the quantity of execution units in processor 101. In another embodiment, the quantity of instructions included in VLIW packet 102A is equal to the quantity of execution units in processor 101. In another embodiment, a quantity of instructions included in VLIW packet 102A exceeds a quantity of execution units in processor 101.

In FIG. 1, processor 101 includes two execution units 120 and 122. Selected instruction 124 may be routed to an execution unit based on the slot with which selected instruction 124 is associated. In an example, instruction 112 in slot 0 and instruction 114 in slot 1 may enter a different execution unit from instruction 116 in slot 2 and instruction 118 in slot 3. In an example, slots 0 and 1 timeshare execution unit 120, and slots 2 and 3 timeshare execution unit 122. Accordingly, instruction 112 in slot 0 and instruction 114 in slot 1 may be routed to execution unit 120 that executes instructions associated with slots 0 and 1. Similarly, instruction 116 in slot 2 and instruction 118 in slot 3 may be routed to execution unit 122 that executes instructions associated with slots 2 and 3.

In an embodiment, instructions may be grouped into different instruction types, and each instruction is associated with a slot based on the instruction type. Examples of the instruction type are an arithmetic instruction type and a memory instruction type (e.g., load and store instructions). In an example, each instruction includes an instruction class field that indicates an instruction type, and the contents of the instruction class field indicate the slot in which the instruction should be placed.

Further, each slot may be associated with a data path. A slot may be associated with, for example, an execution data path or a memory data path. In an embodiment, one or more slots share a common execution data path or a common memory data path. In an example, instructions of a memory instruction type are sent to execution unit 120 along a memory data path 130, and instructions of an arithmetic instruction type are sent to execution unit 122 along an execution data path 132. Slots 0 and 1 may be associated with memory data path 130 and execution unit 120, and slots 2 and 3 may be associated with execution data path 132 and execution unit 122. Accordingly, instruction 112 in slot 0 and instruction 114 in slot 1 are associated with memory data path 130 and sent to execution unit 120. Execution unit 120 may then execute the instruction, and processor 101 may access memory based on executing one or more of instructions of the multiple instructions included in the VLIW packet. Similarly, instruction 116 in slot 2 and instruction 118 in slot 3 are associated with execution data path 132 and sent to execution unit 122. Execution unit 122 may then execute the instruction, and processor 101 may access memory based on executing one or more of instructions of the multiple instructions included in the VLIW packet. An access to memory may include reading from a memory or writing to memory.

FIG. 2 is a block diagram 200 illustrating the execution of multiple instructions in one or more slots, according to an embodiment. Diagram 200 includes VLIW packet 202 including multiple instructions. The multiple instructions include instruction 204 in slot 0, instruction 206 in slot 1, instruction 208 in slot 2, and instruction 210 in slot 3. The instructions may be executed using execution units 120 and/or 122. In an example, slots 0 and 1 are associated with a common memory data path 130, and slots 2 and 3 are associated with a common execution data path 132. Accordingly, instructions in slots 0 and 1 may share execution unit 120, and instructions in slots 2 and 3 may share execution unit 122.

In FIG. 2, processor 101 may execute a thread “T0” associated with instructions 204, 206, 208, and 210 in VLIW packet 202. In an example, to execute instruction 204 “V15=VMEM(R1)” in execution unit 120, processor 101 reads an address to a memory location based on R1, fetches element data values stored at the memory location, and places the fetched element data values into vector register V15. In another example, to execute instruction 206 “V5=VMEM (R0)” in execution unit 120, processor 101 reads an address to a memory location based on R0, fetches element data values stored at the memory location, and places the fetched element data values into vector register V5.

In another example, to execute instruction 208 “V11=VSUB (V12, V13)” in execution unit 122, processor 101 reads element data values from vector registers V12 and V13, computes a difference element-wise of the element data values in vector registers V12 and V13, and places the results into vector register V11. In another example, to execute instruction 210 “V1=VADD (V3, V5)” in execution unit 122, processor 101 reads element data values from vector registers V3 and V5, computes a sum element-wise of the element data values in vector registers V3 and V5, and places the results into vector register V1.

Processor 101 may execute the multiple instructions in VLIW packet 202. The multiple instructions may include a first set of instructions in a first plurality of slots and a second set of instructions in a second plurality of slots. An instruction of the first set of instructions may be executed in parallel with an instruction of the second set of instructions. The first plurality of slots may be associated with a first instruction type, and the second plurality of slots may be associated with a second instruction type.

In an example, the first set of instructions may be instructions 204 and 206, and the second set of instructions may be instructions 208 and 210. Further, the first plurality of slots may be slots 0 and 1 and may be associated with memory data path 130, and the second plurality of slots may be slots 2 and 3 and may be associated with execution data path 132. At a step 220, instruction 210 in slot 3 enters execution unit 122 along execution data path 132. At a step 222, instruction 206 in slot 1 enters execution unit 120 along memory data path 130. Processor 101 may start execution of instruction 210 in execution unit 122 before starting execution of instruction 206 in execution unit 120. Instructions 206 and 210 may be executed concurrently. An advantage to concurrent processing of instructions is faster processing compared with sequential processing of these instructions. The execution order of the instructions may also be reversed. For example, instruction 206 may be executed before instruction 210.

At a step 224, instruction 208 in slot 2 enters execution unit 122 along execution data path 132. At a step 226, instruction 204 in slot 0 enters execution unit 120 along memory data path 130. Processor 101 may start execution of instruction 208 in execution unit 122 before starting execution of instruction 204 in execution unit 120. Instructions 204 and 208 may be executed concurrently. The execution order of the instructions may also be reversed. For example, instruction 204 may be executed before instruction 208.

In this way, the execution units may be shared among the instructions in the one or more slots in a timeshared manner. Further, instruction 210 in slot 3 starts execution in execution unit 122 before instruction 208 in slot 2 starts executions. Similarly, instruction 206 in slot 1 starts execution in execution unit 120 before instruction 204 in slot 0 starts execution.

In an embodiment, processor 101 may execute one to P threads, where P is a whole number greater than zero, and execution units 120 and 122 may be shared among the one to P threads. In an example, a first thread may be executed in parallel with a second thread to take advantage of the faster performance of parallel execution of threads.

### B. Phase Based Slicing

The vector registers referenced in the instructions may include large vectors of data elements. In an example, a vector register may be 1024 bits wide. Execution units 120 and/or 122 may be unable to process this amount of data in one cycle. It may be desirable to execute the instruction in a plurality of phases such that subsets of data elements in the large vectors of data elements are processed per cycle. In an example, data elements in a vector register are processed in a plurality of phases such that a first subset of data elements in one or more vector registers is processed in a phase and then a second subset of data elements in one or more vector registers is processed in a subsequent phase. For simplicity, the instruction is described as being executed in two phases. This is not intended to be limiting. In another embodiment, the instruction may be executed in more than two phases.

In an embodiment, executing the instruction in the plurality of phrases includes identifying first and second subsets of data elements associated with the instruction, processing in a first phase the first subset of data elements, and computing a first output based on the processing in the first phase. Executing the instruction in the plurality of phases may also include processing in a second phase the second subset of data elements and computing a second output based on the processing in the second phase. The second phase may start at least one clock cycle after the first phase starts.

Further, the subsets of data elements may be associated with a common data path and processed in the plurality of phases within the same execution unit. In an example, the plurality of phases of an instruction execution may be pipelined in the processor such that the plurality of phases is executed within the same execution unit. In this way, the instruction may be efficiently executed without adding additional hardware to the processor.

FIG. 3 is a block diagram 300 illustrating the execution of an instruction in a slot in a plurality of phases, according to an embodiment.

Referring to FIG. 2, instruction 210 at step 220 and instruction 206 at step 222 of FIG. 2 may be processed in a plurality of phases. Processor 101 may split instruction 210 into a first plurality of phases and execute instruction 210 in the first plurality of phases. Similarly, processor 101 may split instruction 206 into a second plurality of phases and execute instruction 206 in the second plurality of phases.

In FIG. 3, instruction 210 may be executed in a first phase 220A and in a second phase 220B. Similarly, instruction 206 may be executed in a first phase 222A and in a second phase 222B. In first phase 220A, processor 101 may read a first subset of element data values from vector registers V3 and V5, compute a first output by computing a sum element-wise based on the first subset of element data values from V3 and V5, and place the first output into vector register V1. In second phase 220B, processor 101 may read a second subset of element data values from vector registers V3 and V5, compute a second output by computing a sum element-wise based on the second subset of element data values from V3 and V5, and place the second output into vector register V1. The first subset of data elements may be different from the second subset of data elements. Instruction 208 may be executed in a single phase as in FIG. 2.

In a like manner, instruction 206 may be executed in a plurality of phases (e.g., a first phase 222A and a second phase 222B), and instruction 204 may be executed in a single phase.

For simplicity, the first and second outputs are described as being placed into a single vector register (e.g., vector register V1). This is not intended to be limiting. In another embodiment, the first and second outputs may be placed into more than one vector register. For example, referring to the example above, the first output may be written to vector register V1 and the second output may be written to vector register V0.

### C. Write Patterns

The output of a phase may be written out using different write patterns. For example, the outputs of the plurality of phases may be widened or truncated. A crossbar may be connected to an execution unit and used to move data, truncate data, and widen data, and process an instruction in a plurality of phases. In an example, processor 101 includes an interconnect network such as a crossbar to widen the output, and processor 101 may write the widened output to a register file.

Processing subsets of data elements in phases may enable writing the outputs computed in different phases at different times. In an embodiment, processor 101 identifies an instruction type of an instruction and accesses memory in the plurality of phases based on the instruction type.

Processor 101 may compute the first output based on processing the first subset of data elements in the first phase and compute the second output based on processing the second subset of data elements in the second phase. In an example, the first output is written in the first phase to a vector register and the second phase is not used.

In another example, the second output is written in the second phase to a vector register and the second phase is independent of the first phase. For instance, if the instruction type is of a second type, processor 101 writes in the second phase the second output to a vector register.

In another example, the first and second outputs are computed and written in the second phase to a vector register. For example, the first output is not written to a vector register until the second output is computed. This may occur if the first output is dependent on the second output. After the second output is computed, processor 101 may write in the second phase the first and second outputs to a vector register. For instance, if the instruction type is of a third type, processor 101 writes in the second phase the second output to a vector register without writing in the first phase the first output.

It may be desirable to widen or truncate the one or more outputs of a plurality of phases based on processing a subset of data associated with an instruction. An output may be “widened” to include more space or “truncated” to include less space relative to the operands used in the instructions. In an example, a result of multiplying two operands may require a greater number of bits than is present in each of the operands. Accordingly, it may desirable to widen the output of the phases.

Widening an output may include writing the output into two different vector registers In an example, the first output is written in the first phase to the lower half of a first vector register and to the lower half of a second vector register, and the second output is written in the second phase to the upper half of the first vector register and to the upper half of the second vector register. For instance, if the instruction type is of a fourth type, processor 101 writes in the first phase the first output to a lower portion of a first vector register and to a lower portion of a second vector register and writes in the second phase the second output to an upper portion of the first vector register and to an upper portion of the second vector register. In this way, an output may be “widened.”

In contrast, it may be desirable to truncate the output. Truncating an output may include writing the outputs of a plurality of phases into a single vector register. In an example, the first output is written in the first phase to a vector register and the second output is written in the second phase to the same vector register. The first output may be written in the first phase to a lower half of a vector register, and the second output may be written in the second phase to an upper half of the same vector register. For instance, if the instruction type is of a fifth type, processor 101 writes in the first phase the first output to a lower portion of a vector register and writes in the second phase the second output to an upper portion of the same vector register. In this way, an output may be “truncated” and use less space to store the output than the operands. For instance, an operation performed on a 64 bit value may be truncated to 32 bits and written to a vector register.

Additionally, a memory may include a plurality of memory banks and executing a memory instruction type may include writing in the first phase to a first memory bank of the plurality of memory banks and writing in the second phase to a second memory bank of the plurality of memory banks. In an example, an instruction type is identified as being a memory instruction type. When processor 101 accesses the memory based on the memory instruction type, processor 101 may write in the first phase to a first memory bank and write in the second phase to a second memory bank. Because the processor switches between the first and second memory banks, they may be run at half-speed. This may provide advantages such as less power consumption.

These are examples of different write patterns that may be used based on the instruction type. This is not intended to be limiting and other write patterns may be implemented.

### D. Forwarding Network

Processor 101 may include a forwarding network that forwards an output in a stage of the pipeline to an earlier or later stage in the pipeline. The first and second outputs based on the processing in the first and second phases may be computed in a pipeline of processor 101. In an example, the first output may be forwarded to an earlier or later stage in the pipeline and used to compute another output (e.g., second output) within a common execution unit. Forwarding within an execution unit may provide a quick way to forward the output in contrast to forwarding the output to another execution unit (e.g., from execution unit 120 to execution unit 122). In an example, a local wire may be used to forward an output in a stage of the pipeline to an earlier or later stage in the pipeline within a common execution unit. Forwarding the first output to an earlier or later stage in the pipeline may include using a crossbar to forward the first output.

In FIG. 3, a first output of step 220A and a second output of step 220B are computed by the same execution unit. Further, the first output may be forwarded to an earlier or later stage of the same pipeline within the same execution unit. In an example, the first output may be forwarded to an earlier or later stage within execution unit 122 such that the first output is used in the computation of another output in the plurality of phases (e.g., the second output).

As discussed above and further emphasized here, FIGS. 1-3 are merely examples, which should not unduly limit the scope of the claims. For example, although VLIW packet 102 is shown as including four instructions. VLIW packet 102 may include fewer than or more than four instructions. VLIW 102 may be a variable size packet.

Further, although processor 101 in FIG. 1 is illustrated as receiving a VLIW packet including multiple instructions, in another embodiment processor 101 may receive a packet including one instruction. Further, in another embodiment, processor 101 executes at least one instruction in a plurality of phases.

FIG. 4 is a block diagram 400 illustrating the execution of instruction 210 in a plurality of phases, according to an embodiment. Processor 101 may receive a packet including instruction 210 and may execute instruction 210 using execution unit 120. Instruction 210 may be routed to execution unit 120 along data path 130 and processed in two phases 420A and 420B. Processor 101 may execute instruction 210 in phases 420A and 420B.

For simplicity, diagram 400 illustrates the execution of a single instruction in a plurality of phases. This is not intended to be limiting. Processor 101 may receive at least one instruction (e.g., two or more instructions) and execute one or more of the received instructions in a plurality of phases. Likewise, although two phases 420A and 420B are illustrated, other embodiments having more phases are within the scope of this disclosure.

Further, instruction 210 may be associated with a slot that is associated with an execution data path or a memory data path. In an embodiment, processor 101 executes multiple instructions including instruction 210 in one or more slots in a time shared manner, the one or more slots being associated with an execution data path or a memory data path.

In an embodiment, processor 101 is a co-processor that receives VLIW packet 102 from another processor. The processor may fetch instructions from an instruction cache and execute some instructions itself and send some instructions to co-processor 101 for execution. When the processor sends instructions to co-processor 101 for execution, the processor is able to execute other instructions. In this way, more instructions may be executed per cycle. In an example, co-processor 101 receives from the processor a packet including the multiple instructions and executes the multiple instructions in one or more slots in a time shared manner. Each slot may be associated with an execution data path. In another example, co-processor 101 receives from the processor a packet including at least one instruction and executes an instruction of the at least on instruction in a plurality of phases.

Further, co-processor 101 may execute one or more threads. Each thread may have its own state and maintain data associated with the thread in one or more vector registers. In an embodiment, a thread is designated as being a co-processor capable thread. The thread may be associated with a thread specific register that includes a designation bit. The thread may have privileges to co-processor 101 based on the designation bit. In an example, if the designation bit is set, the thread has access to co-processor 101 and may be executed by co-processor 101. Referring to FIG. 3, thread T0 has its designation bit set so that thread TO may access co-processor 101. In another example, if the designation bit is not set, the thread does not have access to co-processor 101 and co-processor 101 does not execute the thread.

### III. Example Methods

FIG. 5 is a simplified flowchart illustrating a method 500 for executing multiple instructions in one or more slots, according to an embodiment. Method 500 is not meant to be limiting and may be used in other applications.

Method 500 includes steps 510-520. In a step 510, a packet including multiple instructions is received. In an example, processor 101 receives a packet including multiple instructions. Referring to FIG. 1, processor 101 may receive packet 102A including instructions 112, 114, 116, and 118. Each instruction may be associated with a slot. For example, instruction 112 is associated with slot 0, instruction 114 is associated with slot 1, instruction 116 is associated with slot 2, and instruction 118 is associated with slot 3. The multiple instructions may be an input into a multiplexor (e.g., N:1 Slot Mux 122), and the multiplexor may select an instruction from the input. The selected instruction may be routed to an execution unit based on the slot with which the selected instruction is associated.

In a step 520, the multiple instructions in one or more slots are executed in a time shared manner, each slot being associated with an execution data path or a memory data path. In an example, processor 101 executes the multiple instructions in one or more slots in a time shared manner, each slot being associated with an execution data path or a memory data path. Referring to FIG. 2, processor 101 may receive packet 202 including multiple instructions. The multiple instructions may include instructions 204, 206, 208, and 210. Instruction 204 is associated with slot 0, instruction 206 is associated with slot 1, instruction 208 is associated with slot 2, and instruction 210 is associated with slot 3. The multiple instructions in slots 0, 1, 2, and 3 may be executed in a time shared manner using execution units 120 and 122.

Further, each of the slots 0, 1, 2, and 3 may be associated with a memory data path or an execution data path. Slots 0 and 1 may be associated with memory data path 130, and slots 2 and 3 may be associated with execution data path 132. Accordingly, instruction 204 in slot 0 and instruction 206 in slot 1 may be routed along memory data path 130 to execution unit 120, and instruction 208 in slot 2 and instruction 210 in slot 3 may be routed along execution data path 132 to execution unit 122. Although slots 0 and 1 are illustrated as being associated with execution unit 120 and memory data path 130 and slots 2 and 3 are illustrated as being associated with execution unit 122 and execution data path 132, the slots may be associated with a different data path or different execution unit without departing from the spirit of this disclosure.

In FIG. 2, instruction 210 in slot 3 is executed, and then instruction 206 in slot 1 is executed. Similarly, instruction 208 in slot 2 is executed, and then instruction 204 in slot 0 is executed. In this way, the multiple instructions may be executed in a time shared manner. The execution order of the instructions may be in a different order from that described without departing from the spirit of this disclosure. For example, instruction 204 in slot 0 may be executed before instruction 208 in slot 2.

It is also understood that additional method steps may be performed before, during, or after steps 510-520 discussed above. For example, method 500 may include steps of splitting an instruction into a plurality of phases and executing the instruction in the plurality of phases. It is also understood that one or more of the steps of method 500 described herein may be omitted, combined, or performed in a different sequence as desired.

FIG. 6 is a simplified flowchart illustrating a method 600 for executing at least one instruction in a plurality of phases, according to an embodiment. Method 600 is not meant to be limiting and may be used in other applications.

Method 600 includes steps 610-630. In a step 610, a packet including at least one instruction is received. In an example, processor 101 receives a packet including at least one instruction. Referring to FIG. 2, processor 101 may receive packet 202 including at least one instruction. Packet 202 includes instructions 204, 206. 208, and 210. An instruction included in packet 202 may be associated with a large quantity of data to process such that it may be desirable to split the execution of the instruction in a plurality of phases.

In a step 620, an instruction of the at least one instruction is split into a plurality of phases. In an example, processor 101 splits an instruction of the at least one instruction into a plurality of phases. Referring to FIG. 4, instruction 210 is split into a plurality of phases including a first phase 420A and a second phase 420B. Although two phases 420A and 420B are illustrated, other embodiments having more phases are within the scope of this disclosure.

In a step 630, the instruction is executed in the plurality of phases. In an example, processor 101 executes the instruction in the plurality of phases. In first phase 420A, instruction 210 is executed in execution unit 120, and a first subset of data elements may be processed. A first output may be computed based on the processing in first phase 420A. Similarly, in second phase 420B, instruction 210 is executed in execution unit 120, and a second subset of data elements may be processed. A second output may be computed based on the processing in second phase 420B.

It is also understood that additional method steps may be performed before, during, or after steps 610-630 discussed above. For example, method 600 may include a step of executing a multiple sets of instructions in one or more slots in a time shared manner, each slot being associated with an execution data path or a memory data path. It is also understood that one or more of the steps of method 600 described herein may be omitted, combined, or performed in a different sequence as desired.

### IV. Example Wireless Device

FIG. 7 is a block diagram illustrating a wireless device 700 including a digital signal processor, according to an embodiment. Device 700 includes a processor, such as a digital signal processor (DSP) 701 to process a plurality of instructions in a VLIW packet 702. The VLIW packet 702 includes instructions 704, 706, 708, and 710. In an example, DSP 701 processes instructions 704, 706, 708, and 710 according to one or more of FIGS. 1-5, and according to one or more of the methods of FIGS. 5 and 6, or any combination thereof.

FIG. 7 also shows a display controller 730 that is coupled to DSP 701 and to a display 732. A coder/decoder (CODEC) 734 may also be coupled to DSP 701. A speaker 736 and a microphone 738 may be coupled to CODEC 734. Additionally, a wireless controller 740 may be coupled to DSP 701 and to a wireless antenna 748. In an embodiment, DSP 701, display controller 732, memory 750, CODEC 734, and wireless controller 740 are included in a system-in-package or system-on-chip device 756.

In an embodiment, input device 730 and a power supply 760 are coupled to system-on-chip device 756. Moreover, in an embodiment, as illustrated in FIG. 7, display 728, input device 730, speaker 736, microphone 738, wireless antenna 748, and power supply 760 are external to system-on-chip device 756. Each of display 732, input device 730, speaker 736, microphone 738, wireless antenna 748, and power supply 760 may be coupled to a component of system-on-chip device 756, such as an interface or a controller.

Those of skill would further appreciate that the various illustrative logical blocks, configurations, modules, circuits, and steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims. Thus, the present disclosure is limited only by the claims.

What is claimed is:

1. A method for executing multiple instructions in one or more slots, comprising:
receiving a packet comprising multiple instructions; and
executing the multiple instructions in one or more slots in a time shared manner, each slot being associated with an execution data path or a memory data path.

2. The method of claim 1, wherein the multiple instructions comprise a first instruction in a first slot of the one or more slots and a second instruction in a second slot of the one or more slots, and the executing the multiple instructions comprises executing in an execution unit the first instruction before executing in the execution unit the second instruction, the first and second slots being associated with a common execution data path or with a common memory data path.

3. The method of claim 2, wherein the executing in an execution unit the first instruction comprises splitting the first instruction into a plurality of phases and executing the first instruction in the plurality of phases.

4. The method of claim 3, wherein the executing the first instruction in the plurality of phases comprises:
identifying first and second subsets of data elements associated with the first instruction;
processing in a first phase the first subset of data elements;
computing a first output based on the processing in the first phase;
processing in a second phase the second subset of data elements; and
computing a second output based on the processing in the second phase, the second phase starting at least one clock cycle after the first phase starts.

5. The method of claim 4, further comprising:
identifying an instruction type of the first instruction; and
accessing memory in the plurality of phases based on the instruction type.

6. The method of claim 5, wherein the accessing memory in the plurality of phases based on the instruction type comprises:
if the instruction type is of a first type, writing in the second phase the second output to a vector register without writing in the first phase the first output;
if the instruction type is of a second type, writing in the first phase the first output to a first vector register and writing in the second phase the second output to a second vector register;
if the instruction type is of a third type, widening the output of the plurality of phases, wherein the widening includes writing in the first phase the first output to a lower portion of the first vector register and to a lower portion of the second vector register and writing in the second phase the second output to an upper portion of the first vector register and to an upper portion of the second vector register; and
if the instruction type is of a fourth type, truncating the output of the plurality of phases, wherein the truncating includes writing in the first phase the first output to a lower portion of the first vector register and writing in the second phase the second output to an upper portion of the first vector register.

7. The method of claim 5, wherein the identifying an instruction type of the first instruction comprises identifying a memory instruction type, wherein the accessing memory in the plurality of phases comprises writing in the first phase the first output to a first memory bank and writing in the second phase the second output to a second memory bank.

8. The method of claim 4, wherein the computing a first output comprises computing in an execution unit the first output in a pipeline, the method further comprising:
forwarding the first output to an earlier stage in the pipeline such that the first output is used in computing in the execution unit another output.

9. The method of claim 8, wherein the forwarding the first output to an earlier stage in the pipeline comprises using a crossbar to forward the first output.

10. The method of claim 1, wherein the multiple instructions comprises a first set of instructions and a second set of instructions,
wherein the executing the multiple instructions comprises executing the first set of instructions in a first plurality of slots of the one or more slots and executing the second set of instructions in a second plurality of slots of the one or more slots,
the first plurality of slots being associated with the execution data path and the second plurality of slots being associated with the memory data path, and
an instruction of the first set of instructions is executed in parallel with an instruction of the second set of instructions.

11. The method of claim 1, further comprising:
accessing memory based on executing an instruction of the multiple instructions.

12. A processor comprising:
a fetch unit to receive a packet comprising multiple instructions; and
one or more execution units to execute the multiple instructions in one or more slots in a time shared manner, wherein each slot is associated with an execution data path or a memory data path.

13. The processor of claim 12, wherein the one or more execution units splits an instruction of the multiple instructions into a plurality of phases and executes the instruction in a first phase of the plurality of phases and in a second phase of the plurality of phases.

14. The processor of claim 13, wherein the one or more execution units processes in the first phase a first subset of data elements associated with the instruction, computes a first output based on the processing in the first phase, processes in the second phase a second subset of data elements associated with the instruction, and computes a second output based on the processing in the second phase, wherein the second phase starts at least one clock cycle after the first phase.

15. A computer-readable medium having stored thereon computer-executable instructions for performing operations, comprising:
receiving a packet comprising multiple instructions: and
executing the multiple instructions in one or more slots in a time shared manner, each slot being associated with an execution data path or a memory data path.

16. An apparatus for executing multiple instructions in one or more slots, comprising:
means for receiving a packet comprising multiple instructions; and
means for executing the multiple instructions in one or more slots in a time shared manner, each slot being associated with an execution data path or a memory data path.

17. A method for executing at least one instruction in a plurality of phases, comprising
receiving a packet comprising at least one instruction:
splitting an instruction of the at least one instruction into a plurality of phases; and
executing the instruction in the plurality of phases.

18. The method of claim 17, wherein the executing the instruction in the plurality of phases comprises:
identifying first and second subsets of data elements associated with the instruction,
processing in a first phase the first subset of data elements,
computing a first output based on the processing in the first phase,
processing in a second phase the second subset of data elements,
computing a second output based on the processing in the second phase, the second phase starting at least one clock cycle after the first phase starts.

19. The method of claim 17, further comprising:
identifying an instruction type of the instruction; and
accessing memory in the plurality of phases based on the instruction type.

20. The method of claim 19, wherein the accessing memory in the plurality of phases based on the instruction type comprises:
if the instruction type is of a first type, writing in the second phase the second output to a vector register without writing in the first phase the first output;
if the instruction type is of a second type, writing in the first phase the first output to a first vector register and writing in the second phase the second output to a second vector register;
if the instruction type is of a third type, widening the output of the plurality of phases, wherein the widening includes writing in the first phase the first output to a lower portion of the first vector register and to a lower portion of the second vector register and writing in the second phase the second output to an upper portion of the first vector register and to an upper portion of the second vector register; and
if the instruction type is of a fourth type, truncating the output of the plurality of phases, wherein the truncating includes writing in the first phase the first output to a lower portion of the first vector register and writing in the second phase the second output to an upper portion of the first vector register.

21. The method of claim 18, wherein the computing a first output comprises computing in an execution unit the first output in a pipeline, the method further comprising:
forwarding the first output to an earlier stage in the pipeline such that the first output is used in computing in the execution unit another output.

22. The method of claim 17, wherein the receiving a packet comprises receiving the first instruction and a second instruction, and
wherein the executing the instruction in the plurality of phases comprises executing the first and second instructions in one or more slots in a time shared manner, each slot being associated with an execution data path or a memory data path.

23. A processor comprising:
a fetch unit to receive a packet comprising at least one instruction; and
one or more execution units to split an instruction of the at least one instruction into a plurality of phases and execute the instruction in the plurality of phases.

24. The processor of claim 23, wherein the one or more execution units identify first and second subsets of data elements associated with the instruction, process in a first phase the first subset of data elements, compute a first output based on the processing in the first phase, process in a second phase the second subset of data elements, and compute a second output based on the processing in the second phase, wherein the second phase starts at least one clock cycle after the first phase starts.

25. The processor of claim 23, wherein the fetch unit receives in the packet a first instruction and a second instruction, and the one or more execution units execute the first and second instructions in one or more slots in a time shared manner, wherein each slot is associated with an execution data path or a memory data path.

26. A computer-readable medium having stored thereon computer-executable instructions for performing operations, comprising:
receiving a packet comprising at least one instruction;
splitting an instruction of the at least one instruction into a plurality of phases; and
executing the instruction in the plurality of phases.

27. An apparatus for executing multiple instructions in one or more slots, comprising:
means for receiving a packet comprising at least one instruction;
means for splitting an instruction of the at least one instruction into a plurality of phases; and
means for executing the instruction in the plurality of phases.
